(19) United States
(12) Patent Application Publication
(10) Pub. No.: US 2013/0303212 A1
(43) Pub. Date: Nov. 14, 2013

(54) MESSAGING ROUTING

(71) Applicants: Jim Plimmer, Sherfield English (GB); Simon Dumbleton, Lower Earley (GB)

(72) Inventors: Jim Plimmer, Sherfield English (GB); Simon Dumbleton, Lower Earley (GB)

(73) Assignee: MARKPORT LIMITED, Dublin (IE)

(21) Appl. No.: 13/980,187

(22) PCT Filed: Mar. 29, 2012
(86) PCT No.: PCT/IE2012/000015

§ 371 Date: Jul. 17, 2013

Related U.S. Application Data
(60) Provisional application No. 61/469,181, filed on Mar. 30, 2011.

(51) Int. Cl. H04W 4/14

(52) U.S. Cl. CPC H04W 4/14
USPC 455/466

(57) ABSTRACT

In a message routing method an application or device sends a message in a mobile network, the message having a status report request. The message is delivered via network elements including a router, and the router routs a status report to the originating device or application which cannot accept it. The router communicates with a message service centre having store-and-forward capability, and the message service centre performs a re-try of sending the status report to the originating device or application. The status report may be embedded in an otherwise conventional message to the service centre, which may for example be an SMSC. The status report may be embedded in a conventional SMC-MO PDU, without affecting the GSM or other network protocol.

### INTRODUCTION

The invention relates to message routing in mobile networks.

The evolution of SMS core network technology has seen the introduction of an SMS Router device (Acision Message Controller™ for example) that implements efficient message delivery. This is without the need for an on-board storage function, unlike a conventional SMSC that is intended to fulfill both store and forward functions.

Problems arise for SMS router devices that do not have (and should not have) on-board storage when a message delivery is not successful due to the current network or handset conditions, for example, if the handset memory is full or is currently not connected to the mobile radio network.

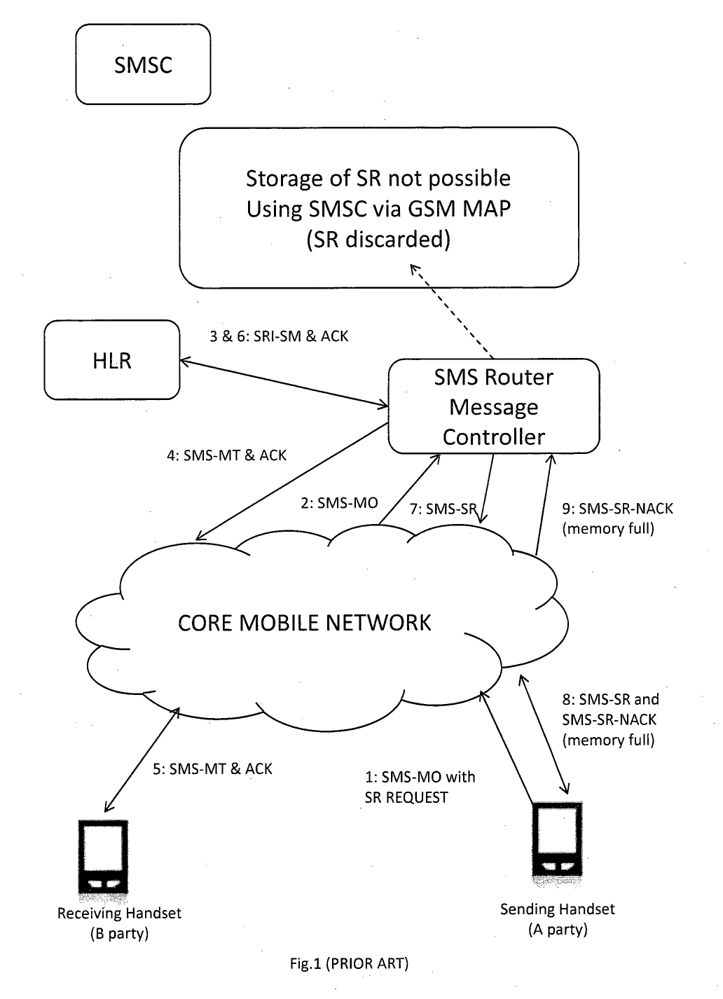

In the case of the failure of the delivery of the message itself, SMS Router devices can forward the original SMS (SMS-MO) message to any SMSC for storage and retries of delivery. However, the same is not true for the failed delivery of a Status Report (“SR”). The GSM MAP specification defines the message format (PDU) of the SR, and this message format is not accepted by an SMSC for storage and retry, preventing the SMS Router or message controller from using the SMSC as a store and forward device for status reports that could not be delivered at the first attempt. This situation is illustrated in FIG. 1.

The invention addresses this problem, and is in general directed towards achieving improved flexibility in message handling.

### SUMMARY OF THE INVENTION

According to the invention, there is provided a message routing method performed in a mobile cutwork comprising a HLR or equivalent, a message service centre, and at least one router, the method comprising the steps of:
an application or device sending a message in a mobile network, the message having a status report request,
the message being delivered via network elements including a router,
the router routing a status report to the originating device or application which can not accept it, and
the router communicating with a message service centre having store-and-forward capability, and the message service centre performing a re-try of sending the status report to the originating device or application.

In one embodiment, the status report is embedded in an otherwise conventional message to the service centre.

In one embodiment, the message service centre is an SMSC.

In one embodiment, the status report is embedded in a conventional SMC-MO PDU, without affecting the GSM or other network protocol.

In one embodiment, the SMS-MO includes a wrapper addressed to a virtual identifier, such that the message is delivered back to the router. Preferably, the wrapper addresses a virtual MSISDN.

In one embodiment, the router unwraps the message when delivered back, extracts the status report, and attempts delivery of the status report.

Preferably, if the delivery attempt fails a network error code is sent back to the service centre, which selects a standard action of the SMSC.

In one embodiment, the router sends a message with an embedded status report to an illegal or private address such that network elements route the message to a special HLR. In one embodiment, the special HLR is the router. In one embodiment, the message is an SMS_MO message.

In one embodiment, a network HLR routes an SRI_SM query on to the router, and the router responds with a routing address such that a message service centre delivers the message to the router, in which the router acts as an HLR and an MSC.

In one embodiment, the router updates a HLR entry causing the HLR to respond to a routing query providing the router address as the recipient, in which the router acts as an MSC.

In one embodiment, the router is assigned a number range that is not in a valid public range such that the network will automatically route all requests for a number in this range to a dedicated HLR address, and the router acts as the HLR for this numbers and replies to a requesting service centre with its own location, and the service centre then delivers a message incorporating the status report to the router, in which the router acts as an HLR and an MSC.

In another aspect, the invention provides a messaging system comprising a router and a message service centre adapted to perform a method as defined above in any embodiment. In one embodiment, the router includes message controller functionality.

In a further aspect, the invention provides a computer program product comprising a computer usable medium having a computer readable program code embodied therein, said computer readable program code adapted to be executed to implement the router method steps and/or the message service centre steps of a method as defined above in any embodiment when executed by a digital processor.

### DETAILED DESCRIPTION OF THE INVENTION

The invention will be more clearly understood from the following description of some embodiments thereof, given by way of example only with reference to the accompanying drawings in which:—

FIG. 1 is a flow diagram illustrating message sequence of the prior art, as described above, and

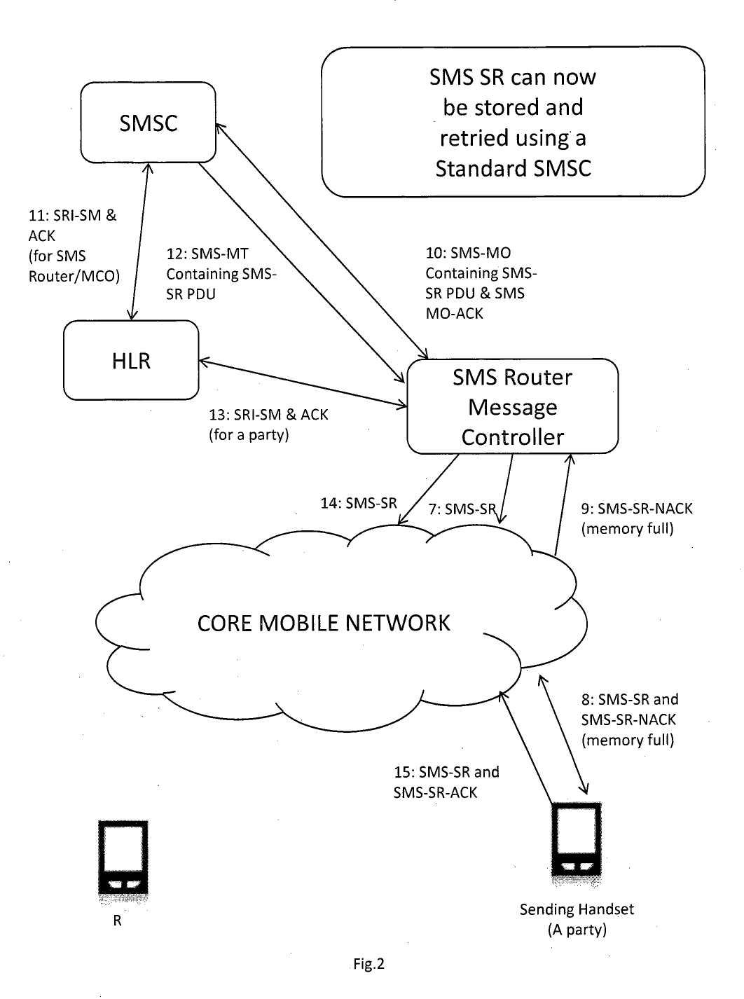

FIG. 2 is a flow diagram of the invention.

### GLOSSARY OF TERMS AND THEIR DEFINITIONS

PDU—Protocol Delivery Unit

SMS—Short Messaging Service

SMS-MO—SMS Mobile Originated

SMS-MT—SMS Mobile Terminated

SR—Status Report

MAP—Mobile Application Part

SMSC—Short Message Service Centre

Alert-SC—Alert Service Centre

MWD—Message Waiting Data

HLR—Home Location Register

SMPP—Short Message Peer to Peer Protocol

In the invention, a network element which acts as an SMS router device and a message controller can utilize any standards-compliant SMSC as a store and retry device for the delivery of status reports that could not be delivered at the first attempt. The network element is referred to in this specification as a router, however it could be a message controller (MCO) or a combined router and MCO.

One approach to this invention is to enhance the GSM specification as it applies to the conventional SMSC, such that the SMSC is enhanced to support the reception, storage and retry of the status report PDU. An SMS router or message controller would require the enhanced SMSC to operate properly, with a dependency between the deployment of an SMS routing device and an upgrade of the SMSC, often from different vendors. That may not always be possible and is always more expensive and risky to deploy than if an SMS router or message controller was deployed alone.

In another embodiment, and referring to FIG. 2 a Status Report PDU is embedded into a conventional SMS-MO PDU, effectively tunneling the SR using a normal SMS-MO, such that the standard SMSC handles the message normally.

The wrapper SMS-MO is addressed to a virtual MSISDN, such that the SMS MT message is always delivered back to the SMS router, which unwraps the SMS-MO, extracts the Status Report and attempts delivery as usual. The Status Report could also be submitted to the SMSC using the same method using SMPP (or EMI-UCP, CIMD2 etc) or by a specific Status Report PDU customization of such a protocol. Other methods of routing the SMS-MO containing the SR are included in the invention.

Should the message delivery fail, the network error code is propagated back to the originating SMSC to select the appropriate retry/delete action.

The SMS router would also either relay the Alert-SC messages to the SMSC, or will control the HLR MWD directly using other GSM MAP standard messages.

Referring again to FIG. 2, Messages 1 through 6 are not shown, for clarity. It is possible that event 15 also fails, at which point the error is relayed to the SMSC and retries would begin from event 11. Alternative SMS-MT interception methods are also possible and supported by this invention. The message process of FIG. 2 (including the unchanged steps 1-6 from FIG. 1) is as follows:
1. The A-party subscriber submits a standard SMS-MO to the Service Centre Address (SCA) of the operator network that includes a request for a delivery Status Report (SR)
2. The SMS-MO message is delivered to the SMS router in the conventional manner.
3. The SMS router queries the HLR for the location of the B-party.
4. The SMS router starts the MT delivery process to the B-Party
5. The SMS is received in conventional manner by the B-party Mobile Station (MS) and an acknowledgement is sent to the SMS router
6. The SMS router must now query the HLR for the location of the A-party to begin the delivery process of the Status Report (SR). The response from the HLR could be negative at this point, and if so, the process would skip over the next steps and start at step 10.
7. The Status Report message is sent to the A-party
8. The A-party may be unavailable or the receiving handset may reject the receipt of the Status Report
9. The negative acknowledgement of the Status Report (or timeout) is indicated to the SMS router. At this point, the SMS router is unable to forward the Status Report to the SMSC for storage and later delivery.
10. On the receipt of the negative delivery result of the Status Report, in this invention, the SMS router embeds the Status Report information within a normal SMS-MO PDU. The SMS-MO with embedded Status Report will be addressed to a virtual MSISDN that is allocated to the SMS router.
11. The SMSC will then begin to try and deliver the SMS message normally (without any knowledge of the content) by requesting the location of the SMS router (virtual) MSISDN
12. The SMS-MT will then be sent to the SMS router.
13. The SMS router is programmed to be aware that the receipt of messages to the virtual MSISDN indicates that the content is actually a Status Report and therefore, the SMS-MT is un-wrapped to expose the parameters of the Status Report. The SMS router therefore queries the HLR for the location of the A-party (that sent the original SMS to the B-party).
14. The Status Report is then sent to the location of the A-party
15. The A-party successfully receives the Status Report for the delivery of the SMS from A-party to B-party. The propogation of the A-party acknowledgement to the source SMSC will then result in the deletion of the SMS in the SMSC. Similarly, if the A-party is still not available or able to receive the Status Report, the negative response will trigger the retry schedule of the SMSC as usual.

In order to get the SMS with the embedded status report back, the SMS router would need to send the MO[SR] to an MSISDN that is home routed or re-routed. This can be done by any home routing method (for example, SRI-SM deflection, or interception) or location update model. The router could address the MO[SR] to an illegal or private number—this would then mean that the core network could be configured to route this “private range” to a dedicated HLR that would be the router (or MCO) itself. This makes the realisation of the invention simpler in at least some embodiments.

The undeliverable Status Report is encapsulated in a normal SMS-MO protocol unit which must be addressed to a recipient (A-party) that the core network is configured to deliver to the router, rather than an actual handset. There are multiple ways to achieve this, including:
SMS Home Routing using SRI-SM forwarding—here the network HLR is aware that the recipient is a “special” case, and the SRI-SM request is forwarded directly to the router. The router will then respond with a routing address such that the SMSC will deliver the message normally to the router. In this case the router (or an MCO) acts as an HLR and an MSC.
SMS Location Update (Virtual Mobile). The router updates a normal HLR entry (that does not in reality have a SIM in circulation) such that the HLR responds normally to the SMSC to provide the “updated location” of the recipient as the router. In this case the router acts only as an MSC.

Where the network routing is entirely internal to the host network (i.e. no other network is involved in the routing at all), an additional routing option is available. In this case, the router can be assigned a number range that may or may not be a valid “public” range such that the core network will automatically route all requests for this number range to a dedicated HLR address (this happens normally for public numbers). The router would then be the HLR for these special numbers and will reply to the requesting SMSC with a location that is again the router itself. The SMSC will then deliver the SMS to the router. In this case, the router is an HLR and an MSC.

Other methods are also supported, so long as the core network is able to route the message that the SMSC attempts to deliver to the MCO for unwrapping and processing.

The invention is not limited to the embodiments described but may be varied in construction and detail.

1-17. (canceled)

18. A message routing method performed in a mobile network comprising a HLR or equivalent, an SMSC having store-and-forward capability, and at least one SMS router, the method comprising the steps of:
an A-party sending a message to a B-party in the mobile network, the message having a status report request, the message being delivered via network elements including the SMS router,
the SMS router routing a status report to the A-party which can not accept it, and
the SMS router embedding the status report in an otherwise conventional message to the SMSC, and the SMSC performing a re-try of sending the status report to the A-party.

19. The message routing method as claimed in claim 18, wherein the status report is embedded in a conventional SMS-MO PDU, without affecting the GSM or other network protocol.

20. The message routing method as claimed in claim 18, wherein the status report is embedded in a conventional SMS-MO PDU, without affecting the GSM or other network protocol; wherein the SMS-MO includes a wrapper addressed to a virtual identifier, such that the message is delivered back to the router.

21. The message routing method as claimed in claim 18, wherein the wrapper addresses a virtual MSISDN; wherein the status report is embedded in a conventional SMS-MO PDU, without affecting the GSM or other network protocol; wherein the SMS-MO includes a wrapper addressed to a virtual identifier, such that the message is delivered back to the router.

22. The message routing method as claimed in claim 18, wherein the status report is embedded in a conventional SMS-MO PDU, without affecting the GSM or other network protocol; wherein the SMS-MO includes a wrapper addressed to a virtual identifier, such that the message is delivered back to the router; and wherein the SMS router unwraps the message when delivered back, extracts the status report, and attempts delivery of the status report.

23. The message routing method as claimed in claim 18, wherein the status report is embedded in a conventional SMS-MO PDU, without affecting the GSM or other network protocol; wherein the SMS-MO includes a wrapper addressed to a virtual identifier, such that the message is delivered back to the router; and wherein the SMS router unwraps the message when delivered back, extracts the status report, and attempts delivery of the status report; and wherein if the delivery attempt fails a network error code is sent back to the SMSC, which selects a standard action of the SMSC.

24. The message routing method as claimed in claim 18, wherein the SMS router sends a message with an embedded status report to an illegal or private address such that network elements route the message to a special HLR.

25. The message routing method as claimed in claim 18, wherein the SMS router sends a message with an embedded status report to an illegal or private address such that network elements route the message to a special HLR; and wherein the special HLR is the router.

26. The message routing method as claimed in claim 18, wherein the SMS router sends a message with an embedded status report to an illegal or private address such that network elements route the message to a special HLR; and wherein the message is an SMS_MO message.

27. The message routing method as claimed in claim 18, wherein the SMS router sends a message with an embedded status report to an illegal or private address such that network elements route the message to a special HLR; and wherein a network HLR routes an SRI_SM query on to the SMS router, and the SMS router responds with a routing address such that a message service centre delivers the message to the router, in which the router acts as an HLR and an MSC.

28. The message routing method as claimed in claim 18, wherein the SMS router sends a message with an embedded status report to an illegal or private address such that network elements route the message to a special HLR; and wherein the router updates a HLR entry causing the HLR to respond to a routing query providing the router address as the recipient, in which the router acts as an MSC.

29. The message routing method as claimed in claim 18, wherein the SMS router sends a message with an embedded status report to an illegal or private address such that network elements route the message to a special HLR; and wherein the SMS router is assigned a number range that is not in a valid public range such that the network will automatically route all requests for a number in this range to a dedicated HLR address, and the SMS router acts as the HLR for this numbers and replies to a requesting service centre with its own location, and the SMSC then delivers a message incorporating the status report to the SMS router, in which the SMS router acts as an HLR and an MSC.

30. A messaging system comprising an SMS router and an SMSC having store-and-forward capability, wherein:
the SMS router is adapted to deliver a message sent by an A-party to a B-party in a mobile network, the message having a status report request;
the SMS router is adapted to route a status report to the A-party which cannot accept it;
the SMS router is adapted to embed the status report in an otherwise conventional message to the SMSC, and the SMSC is adapted to perform a re-try of sending the status report to the A-party.

31. The messaging system as claimed in claim 30, wherein the router includes message controller functionality.

32. A computer program product comprising a computer usable medium having a computer readable program code embodied therein, said computer readable program code adapted to be executed to implement the router method steps and the message service centre steps of the following method of when executed by a digital processor:
an A-party sending a message to a B-party in the mobile network, the message having a status report request, the message being delivered via network elements including the SMS router,
the SMS router routing a status report to the A-party which cannot accept it, and
the SMS router embedding the status report in an otherwise conventional message to the SMSC, and the SMSC performing a re-try of sending the status report to the A-party.
